(19) United States
(12) Patent Application Publication
(10) Pub. No.: US 2003/0050879 A1
(43) Pub. Date: Mar. 13, 2003

(54) System and method for improved multiple real-time balancing and straight through processing of security transactions

(76) Inventors: Michael Rosen, Los Angeles, CA (US); Thomas Francis Price, Manalapan, NJ (US)

Correspondence Address: Ward & Olivo, 708 Third Ave, New York, NY, 10017, US

(21) Appl. No.: 09/941,155

(22) Filed: Aug. 28, 2001

(51) Int. Cl. G06F 17/60

(52) U.S. Cl. 705/35; 705/37

(57) ABSTRACT

A method and system are provided for comparing data from several different sources in real time to determine inconsistencies between such data. The present invention further and alerts a user to such inconsistencies. The preferred embodiment of the present invention uses such a method and system for identifying exceptions in data from financial markets, brokers and customers to alert a financial institution immediately to inconsistent data with respect to orders, executions and allocations of trade information. In this way, this method and system saves valuable time in identifying such exceptions, thereby allowing a financial institution to correct such exceptions virtually immediately. The system and method described herein also assists a financial institution in complying with the T+3 trading cycle and makes a move to the T+1 trading cycle feasible.

### TECHNICAL FIELD OF THE INVENTION

The present invention relates generally to securities trade transaction processing and settlement with automated process control and risk and compliance management. More particularly, the invention relates to multiple balancing of all three “legs” of a trade in real time, allowing for settlement of a trade intra-day.

### BACKGROUND OF THE INVENTION

The U.S. Securities industry, with revenues in excess of $200 billion in 1999, traded an average of over 1.9 billion shares daily, with an average daily value of $79 billion. Daily share volume grew 27% annually from 700 million shares in 1995 and the pace of this growth was expected to continue and reach 3.6 billion shares traded daily in 2002, according to 1999 Securities Industry Association data. In the first month of 2001, daily trading volume rose to 3.8 billion shares traded

Volume is being driven by fundamental changes in the financial industry, including strong growth in cross-border investment, self-directed investment, new entrants to the marketplace and electronic trading. These changes are pushing existing securities trade processing and settlement systems beyond their capabilities. Industry trade processing efficiency has exhibited a notable decline, with a rising proportion of both institutional trades not being confirmed on the trade date and institutional trades not being affirmed prior to settlement, resulting in a substantial increased risk of settlement failure. Institutional trades not confirmed on the trade date have risen to approximately 18% in 1999 and are projected by the Securities Industry Association (SIA), to grow to approximately 25% by 2002 if the settlement process is not radically redesigned. Institutional trades not affirmed prior to settlement have risen to approximately 12% in 1999 and are projected to rise to approximately 40% by 2002.

Existing trade processing and settlement systems will have their capabilities further stretched with the continuing expansion of trading hours, the decimalization of stock prices and the shortening of the trading cycle from settlement three (3) days after the trade date (T+3) to settlement one (1) day after the trade date (T+1) (proposed to be implemented by June, 2004). Consequently, T+1 is the new “Y2K” of the U.S. Securities industry. Further, customer dissatisfaction with existing processing systems is endemic. Conventional industry processors are tied to antiquated batch legacy systems that are often up to 25 years old and are physically incapable of fully accommodating current industry developments. In particular, existing batch process systems, which require one and one-half days to settle trades, are not capable of settling within one (1) day after the trade date (i.e., T+1).

In combination, these industry developments have added and will continue to add significantly to the magnitude of risk inherent in the securities transaction settlement process—more trades, higher trade values, and faster settlement requirements. In addition, regulatory requirements are becoming more onerous and have imposed substantial requirements for closer monitoring of trading activity by the various participants. This trend is exemplified by the proposed National Association of Securities Dealers (NASD) ruling 2520, which defines day trading and encourages the implementation of intra-day margin and the prompt settlement of margin limits for different stocks. Implementation of ruling 2520 will require real-time risk monitoring and real-time corrective action upon the occurrence of an “out of parameter” event.

Further, there has been a substantial surge in margin purchases of securities. Margin debt loads increased 62% in 1999 to approximately $228.5 billion at year end, according to the Securities Industry Association. When customers purchase on margin, they typically pay only a portion of the price of the security (usually 50%) and borrow the rest from the broker, permitting the customer to leverage positions. Margin accounts are subject to initial and maintenance margin requirements and, in order to protect the broker's loans margin customers are required to provide additional funds when the volatility of their stock portfolio increases. Although the markets may temporarily decrease the margin volume, the long-term trend toward growing volume of margin business introduces further risk, which requires real-time monitoring and corrective action in the settlement process.

The industry changes described above are pushing existing securities trade processing and settlement systems beyond their inherent capabilities. Presently, securities transaction processing is handled by in-house proprietary systems, service bureaus or a combination of both. However implemented, transaction processing systems are all tied to antiquated batch legacy systems that have evolved in an unsystematic manner with add-on solutions, making the systems inordinately difficult to change. Further, many systems in use are still paper and telephone-based, while most computerized systems still require manual intervention in order to complete steps, monitor “out of parameter” situations and manage risk.

In particular, existing batch processing legacy systems are unable to accommodate the proposed move to T+1 since the legacy systems require a minimum of one and one-half days to settle trades. The problem with the move to T+1 cuts across the entire securities industry—it affects the buy side, the sell side, the custodial banks and the clearing brokers. Further, brokers must incur significant expense implementing compliance programs designed to monitor and manage the exposure of individual securities professionals as well as the enterprise as a whole. Because conventional trading is paper and telephone-based, compliance programs are expensive to manage, produce delayed information, and may be circumvented. All of these disadvantages impose an increasing risk to the firm. By way of example, and in conformance with the exemplary semi-schematic flow diagram of a current institutional trade process of FIG. 1, a customer order must move through a series of steps, each incorporating a number of data flows, back and forth between a number of industry players, from order initiation to settlement. Currently, the process is sequential with each step occurring one-after-the-other. FIG. 1 illustrates the detailed processes that currently take place from initiation to settlement of a buy trade of equities, corporate bonds or municipal bonds in the United States for institutional clients. From the exemplary embodiment shown in FIG. 1, it can be seen that there are a number of industry players that are involved at each step of the institutional transaction process. In particular, investment manager 21 functions as the initiator of a buy (or sell) order on behalf of a retail customer. Examples of investment managers include account managers at large, institutional brokerage houses, portfolio managers of a financial institution, etc. Investment manager 21 manages all portions of a client's account and provides analysis and other value added services to the account, as well as functioning as the central nexus for account allocation and settlement instruction tasks.

Upon occurrence of particular conditions, investment manager 21 initiates a buy order on behalf of a customer, and transmits that buy order to broker/dealer 23 as shown in step 39. Broker 23 handles investors' order(s) to buy and sell securities for a commission. Brokers come in three general categories—agency brokers, clearing brokers and executing brokers. All brokers that do customer business act as agency brokers, receiving orders from clients for them to execute as agent. Registered brokers that have a seat on the stock exchange are executing brokers, while only some brokers are able to act as clearing brokers. An executing broker executes customer buy and sell orders on the particular stock exchange of which they are members, while a clearing broker clears and settles trades for other brokers or financial institutions.

Still referring to the exemplary embodiment of FIG. 1, execution of the trade is made by agency broker 23 who sends a trade slip to the floor of exchange 25 where it is executed in step 40. A trade order confirmation is received by broker 23 from exchange 23 in step 41. Broker 23 then calculates a notice of execution (NOE) and the average price for the per-share transaction in step 38. An NOE is sent by broker 23 to investment manager 21 in step 42 who matches the NOE with the customer's buy order in step 37. Once this information matches, and in the case where a client buy order comprises multiple orders distributed among multiple client accounts, investment manager 21 allocates the executed trade results among the appropriate client accounts as shown in step 36.

In the case where the trade is being undertaken for an investment fund or institutional account, which typically uses a custodial bank to clear and settle trades, a trade notification is provided by investment manager 21 to custodian 29 as shown in step 23. Settlement and delivery instructions are generated by investment manager 21 and are forwarded to broker 23 as shown in step 44. Broker 23 enriches trade details with settlement instructions, fees, commissions, taxes, and the like. Broker 23 then confirms the trade and forwards the trade detail to depository 27 shown in step 46.

Preferably, depository 27 is the Depository Trust and Clearing Corporation (DTCC), which is a holding company established in 1999 to oversee the Depository Trust Company (DTC) and the National Securities Clearing Corporation (NSCC). The DTC and NSCC, under the umbrella of the DTCC, provide the primary infrastructure for the clearance, settlement and custody of the vast majority of equity, corporate debt and municipal bond transactions in the United States. The DTCC is the world's largest securities depository and holds over $20 trillion in stocks in custody.

Still referring to FIG. 1, depository 27 receives trade details from broker 23 as shown in step 46 and creates a confirmation that the trade has indeed been executed as shown in step 47. Confirmation is forwarded to investment manager 21 in step 48 who then matches trade confirmations to allocations that have previously been set up as shown in step 49. Alternatively, confirmations are forwarded to custodian 29 in step 50, who, like investment manager 21, generates an affirmation message in step 51 which acknowledges broker's 23 confirmation that a trade has been executed. The affirmation message, from either custodian 29 or investment manager 21 is forwarded to depository 27 in step 52a or 52b, each of which in turn affirms broker's 23 confirmation to both broker 23 and custodian 29 as shown in steps 53a and 53b.

It should be noted that depository 27 need not engage in the confirmation/affirmation process with custodian 29. Depository 27 is able to engage in all of the necessary confirmation/affirmation activities with investment manager 21 and need only issue an affirmed confirm message to custodian 29 as shown in step 53b, who then matches the trade confirmation data with the trade notification information received from investment manager 21.

Upon receipt of an affirmed confirm as shown in step 53, broker 23 authorizes settlement of the trade as shown in step 54. Settlement is the conclusion of the security transaction (i.e., when a customer pays a broker for securities purchased and receives the securities or when a customer delivers the securities sold and receives payment). In particular, securities sold on the New York Stock Exchange (NYSE) are to be delivered to the buying broker by the selling broker and payment made to the selling broker by the buying broker on or before the third business day after the transaction (T+3). Regular delivery for treasury bonds is the following business day. The transfer of payments and securities to execute a trade is made (i.e., cleared) through certain brokers and custodial banks that aggregate securities and payments from executing brokers and transfer the securities and payments to their counter-parties. Thus, settlement may be made by either broker 23 or the custodian 29, with physical transfer of the securities taking place within depository 27.

The present invention also assists in the monitoring of financial securities. There are existing methods and devices for monitoring financial securities, for example, U.S. Pat. No. 5,946,666 to Nevo, et al. Nevo, et al., discloses a method and apparatus for monitoring financial securities markets or financial securities which measures market information for deviations. While Nevo, et al., primarily discloses a method and apparatus for monitoring and recording information regarding financial securities and financial markets, Nevo does not verify, or balance, the basic elements of a trade. Therefore a disadvantage of Nevo is that while it may act as a tool to assist brokers or traders with personal management of specific accounts or portfolios, the system or method of Nevo can not assist a financial institution with the confirmation of the execution of trades. Another disadvantage with the method or system disclosed by Nevo is its inability to track and confirm allocation of bulk trades to their proper accounts.

There are also existing systems for determining risk allocation. For example, U.S. Pat. No. 6,078,904 to Rebane discloses an apparatus and method for determining an investor's risk tolerance and selecting a monetary allocation of investment assets according to a risk tolerance function and risk dispersion characteristics. One disadvantage of the method or system disclosed by Rebane is that it is merely a system to determine an investor's individual risk characteristics. The system only utilizes risk tolerance to determine the proper monetary allocations within a portfolio. The system of Rebane does not compare an investor's prior transactions to alert a broker or investor when an abnormal trade surfaces. The Rebane method or system does not even touch upon the basic elements of a trade, namely orders and executions. Rebane merely discloses a method to keep an investor's risk minimal.

The Securities Industry Association (SIA) has identified a number of limitations in the current trade processing system which will necessarily become magnified with the shortening of trade cycles to T+1 and with the continued volumetric growth in securities transactions. Such pertinent limitations include a number of sequential, repetitive steps inherent in the process but which are, in turn, hampered by manual processes, the lack of cross-industry messaging standards, inefficient use of data and insufficient management information being passed between and among the relevant players.

Trades are currently processed sequentially, with a number of repetitive and often redundant steps. Only one entity is able to review and enrich trade data at a time, with the result that the trade data passes back and forth between the investment manager and the broker/dealer a number of times. Trade data is added incrementally at each pass, whereby each participant waits for a “trigger” before executing the next step, resulting in processing delays and redundant flows of non-essential data. The system, accordingly, operates in a reactive and not a proactive fashion.

The major factor behind current process inefficiencies is the lack of internal automation among the participants. Many systems, whether in-house proprietary systems or vendor systems, fail to adhere to common standards or to fully support the entire trade process, resulting in the need for manual intervention. Trade data is often manually re-keyed into several systems. Custodians' credit and position checks are often performed manually, while affirmations are typically manually reviewed. Trade information is frequently communicated by telephone or facsimile, requiring manual input at the receiving end. Currently, one third of all allocations are manually or verbally transmitted, resulting in a delayed affirmation. The prevalence of such manual processes dramatically increases the chances of error and trade failure. Significant expense is incurred in processing, confirming and clearing paper-based trades.

Digressing momentarily, a “fail” is the name given to a trade transaction that fails to settle within the particular time allotted (i.e., within T+3). In the case of a fail, the clearing broker will not have received the security that must be delivered against payment at settlement. The broker assumes extra costs in the case of a fail by having to borrow the security required to cover the fail. Most commonly, a “fail” occurs as the result of inaccurate, incomplete or missing settlement instructions.

Current processes encounter several difficulties in obtaining and properly using customer, security and settlement data. Manual enrichment of missing data fields and standing settlement instructions is often required throughout the process, leading to errors, processing slow downs and unmatched trades. Where automated systems are available, discrepancies often occur between systems due to the lack of data synchronization and likewise result in unmatched trades and increased manual intervention. Trade processing time is slowed further by the need to include all transaction data in each step of the process. Isolating specific data elements for each specific step of the process would speed processing considerably. Real-time monitoring with end-to-end processing through disparate systems within the post-trade processing cycle is not currently possible due to the sequential nature of the process. There are many potential break points during the transaction cycle which create multiple opportunities for trade failure. Participants are barred from proactive prevention of fails since they are unable to obtain and view real-time status information of their trades at any point within the transaction cycle. The risk already inherent in this process, while controllable at current volume levels, will dramatically increase with volume growth and real-time processing requirements.

The SIA has identified a need for radical streamlining, simplifying and increasing automation in securities trade, clearing and settlement, in order to cope with the new demands being placed upon these systems by not only the proposed shortening of trade transaction cycles, but also by the underlying growth in volume and risk. The implementation of real-time systems and processes is, necessarily, a prerequisite to the implementation of T+1.

In preparation for T+1, the SIA has proposed a standardized industry model, termed the Transaction Flow Monitor (TFM), for post-trade processing. The TFM is a radical redesign of the current industry processing system and is based on a virtual matching utility concept. The SIA hopes that the proposed solution will ease the way to achieving greater levels of straight through processing, volume insensitivity, and enhanced risk management while providing early identification of transaction exceptions. However, current industry processors, such as Automated Data Processing (ADP), will have difficulty responding to the new requirements on a timely basis, tied as they are to the existing batch legacy systems. T+1 and high daily processing volumes will require real-time straight through processing, interoperability with other systems, and process control and risk management functions in order to be effective. Batch systems can be converted through bridging systems, to accommodate real-time straight through processing and interoperability, but will find it impossible to address the operating risk that arises from real-time processing, due to the underlying structure of batch systems that makes real-time system monitoring and data access inherently impossible. Moreover, bridging systems are necessarily custom applications and are, therefore, difficult to create and inordinately expensive.

Implementation of straight through processing will generally insure that trade data is communicated to the various appropriate parties to any particular transaction. Straight through processing will not, however, insure that trade data arrives when it is required or that transactions are being processed in a timely fashion. Straight through processing systems, although capable of processing large volumes of data efficiently and in real-time, lack the process monitoring capabilities that would identify “out of balance” conditions and assist in controlling operating risk.

With regard to the industries' lack of universally accepted messaging standards and protocols, various attempts have been made to converge standards for industry-wide application. A number of different standards are currently in use, including proprietary standards defined by various software vendors or financial firms and open-market systems such as Society for Worldwide Interbank Financial Telecommunication (“SWIFT”), Financial Information Exchange Protocol (“FIX”), and Industry Standardization for Institutional Trade Communication (“ISITC”). Also, middleware message translation solutions have eased the confusion somewhat, but manual intervention, particularly in the case of legacy telephone and facsimile transmissions, is often required.

Accordingly, there is a need, particularly in the circumstances surrounding the planned transition to T+1, for systems and methods that are able to offer a complete real-time processing and settlement methodology that includes operational risk management tools. T+1 will force clearing institutions in the industry at large to upgrade their systems, allowing investment and new systems that will have the ability to change the securities trade transaction processing and settlement paradigm. In the event that T+1 is significantly postponed, this particular need will remain since the discussion around T+1 will have caused the market participants to realize the need for straight through processing, interoperability, and process control and risk management functions in order to respond to volume growth and other long term industry developments.

### SUMMARY OF THE INVENTION

The invention is directed to a real-time securities trade transaction processing and settlement solution. The system's novel capabilities encompass straight through processing, automated process control and operational risk management. Working in conjunction with or independent from the proposed TFM, the novel system of the present invention resolves many of the limitations of existing trade transaction processing systems.

In accordance with the invention, the system is a revolutionary expert system utilizing advanced process control technology adapted from the manufacturing process control industry. Real-time artificial intelligence constructs elaborate decision trees that constantly refine process control procedures via dynamic feedback loops permitting manufacturing processes to continue to operate even as alert conditions are identified and rectified. In the context of securities trade clearing and settlement, the sophisticated mechanisms provide real-time risk management. They are able to monitor in real-time events relating to the balancing of securities. By correlating real-time changes of risk characteristics and portfolios, the system necessarily allows tighter management control.

The novel system of the invention automates a clearing broker's middle-office functions and the back-office purchase and sales (P&S) balancing function in the context of the specification. P&S balancing is traditionally a back-office function wherein transaction receipts and deliveries are matched and balanced. Further, the system provides integrated customer compliance, margin and credit risk monitoring functions, with all functions completed in real-time. The system also monitors the automated processing of transactions and adjusts work flows in real-time.

The present invention relates to a system for securities trade transaction processing and settlement solution. The present invention encompasses a complete system utilizing straight-through-processing, automated process control, and operational risk management in real-time. The system can be utilized in conjunction with the proposed Transactional Flow Model (TFM) or can be utilized independently therefrom. The present invention resolves many of the aforementioned limitations of existing trade transaction processing systems. The present invention uses advanced process control technology, originally adapted for use with the trade transaction industry from the manufacturing process control industry. In the manufacturing process control industry, real-time artificial intelligence constructs decision trees that continuously redefine process control procedures via dynamic feedback loops, thereby permitting the manufacturing processes to continue to operate even as alert conditions are identified and rectified. In the present invention, these sophisticated mechanisms are expanded to provide real-time risk management to securities trade clearing and settlement. The present invention can monitor real-time changes in any risk management category (e.g., beta), detect changes in the performance characteristics of selected securities, and monitor real-time concentration of portfolios. By correlating changes of risk characteristics and portfolios in real-time, the present invention allows tighter management control.

The present invention can also monitor the inner workings of a financial firm. The present invention can compile clearance information such as orders, executions and allocations in real-time, thereby identifying exceptions and inconsistencies on a rolling basis. By identifying patterns in the identified exceptions and drawing conclusions from these, the system can avoid time consuming analysis of future exceptions by offering proposed solutions based on previous solutions to similar exceptions. For example, the system will monitor the flow of trades and, based upon rules and past experience, allocate the work flow in a manner that will complete the work most efficiently. To comply with the T+1 trading cycle, firms will be forced to identify exceptions and inconsistencies in real-time, or suffer great risks in covering those exceptions after the questioned trades have cleared.

The knowledge built over time through this mathematical pattern recognition is highly useful in minimizing a clearing institution's losses and risk, and also offering opportunities to expand business and increase profits. For example, the system can detect client trading patterns, either based on a preferred client profile or on specific client past history, that can help brokers secure extra trading revenue.

Ultimately, the real-time risk management system infrastructure can also monitor the entirety of a firm's positions in real-time, thereby allowing firms to balance multiple capital requirements and determine the most efficient use of capital, resulting in near real-time capital optimization.

The present invention can automate some or all of a clearing broker's middle-office functions, as well as its back-office P&S balancing function. Further, the present invention provides a solution to the issues surrounding customer compliance, margin, and credit risk monitoring functions in a T+1 cycle by integrating the separate tasks into a real-time balancing system. The present invention also monitors the automated processing of transactions and adjusts the distribution of manual work to competent clerks in real-time.

The present invention is a modular, three-tiered software solution that comprises essentially a Real-Time Middle-Office Balancing Module, A Risk Management Module and a Compliance Management Module. Each of the modules can individually operate with existing customer software. Data communications can be transferred through any network, including an intra-net, an industry-wide net or virtual private network. While the present invention could operate on the public Internet, for reasons of security and reliability the present invention preferably operates on a private, protected network. The Middle-Office Real-Time Balancing Module (“MRTB”) is a primary characteristic of the present invention. MRTB can replace existing batch P&S processes in clearing institutions with a system that balances and reconciles information from the stock exchanges and information from clearing institutions in real-time through constant interaction with such information. The present invention therefore allows the logical combination of P&S with middle office functions. MRTB monitors all executions and compares them in real-time with floor reports, interactive NYSE OCS, time and sales reports, and customer allocations. This real-time multiple balancing system immediately and simultaneously compares customer allocation data, street side/floor reports and OCS information, all of which is continuously fed into the system. This “three legged” balancing system provides an advanced method of monitoring trades, confirming transactions and identifying problem areas in real-time, thereby allowing a financial institution to meet the increased operating demands involved with reconciling information with a T+1 cycle.

Alternative embodiments of the present invention can include additional functions such as real-time exception reporting, sensitivity analysis, and rule-based monitoring. These optional operational risk management tools allow the present invention to recognize processes ranging from normal to abnormal, and alert users to potential risks immediately. By prioritizing and reconciling these potential risks, clearing institutions can minimize risk of loss as well as actual losses.

It is an object of the present invention to allow the financial industry to convert from a T+3 to a T+1 trading cycle. By automating the balancing process in real time, a financial institution would be able to meet the demands associated with a T+1 trading cycle. Early detection of exceptions and quick correction of unbalanced information serve to allow a firm to comply with the demands of a T+1 trading cycle.

It is another object of the present invention to allow the financial industry to handle the increased volume of trades due to popularization of the stock markets, e-trading and the like. Increasing volume of trades necessarily translates to an increase in the number of reported exceptions. Rather than identifying such exceptions using an overnight process, a firm can identify these exceptions and correct them during the trading day.

It is yet another object of the present invention to allow the financial industry to handle the recently increased trading hours, and to allow for further expansion of trading hours if desired. Increased trading hours allow for an increase in the volume of trades and therefore, the number of exceptions reported. The present invention can help a firm rapidly correct these exceptions during the trading day.

Another object of the present invention is to support the proposed rule NASD 2520, which sets higher margins and intra-day margin requirements for day traders.

A further object of the present invention is to meet the requirements of Rule 123 of the NYSE and ACT of the NASD, which require complete electronic audit trails and acceptance of trades. The present invention can meet the requirements of Rule 123 by recording electronically the trade information as it passes through the balancing system.

Another object of the present invention is to promote an interactive Online Comparison System (“OCS”) (i.e., intra-day New York Stock Exchange comparisons.)

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 shows a semi-schematic flow diagram of a prior art institutional trade process.

FIG. 2 depicts the system architecture of the preferred embodiment of the present invention.

FIG. 3 shows an overview of the positioning of the present invention within a typical financial industry establishment's existing trading system.

FIG. 4 shows the application architecture of the preferred embodiment of the present invention.

FIG. 5 shows the system topology of one embodiment of the present invention.

FIGS. 6A-6E show typical screen outputs of one embodiment of the present invention taken at different times throughout a typical day, namely 9:30 AM, 12:00 PM, 2:00 PM, 4:00 PM and 4:05 PM.

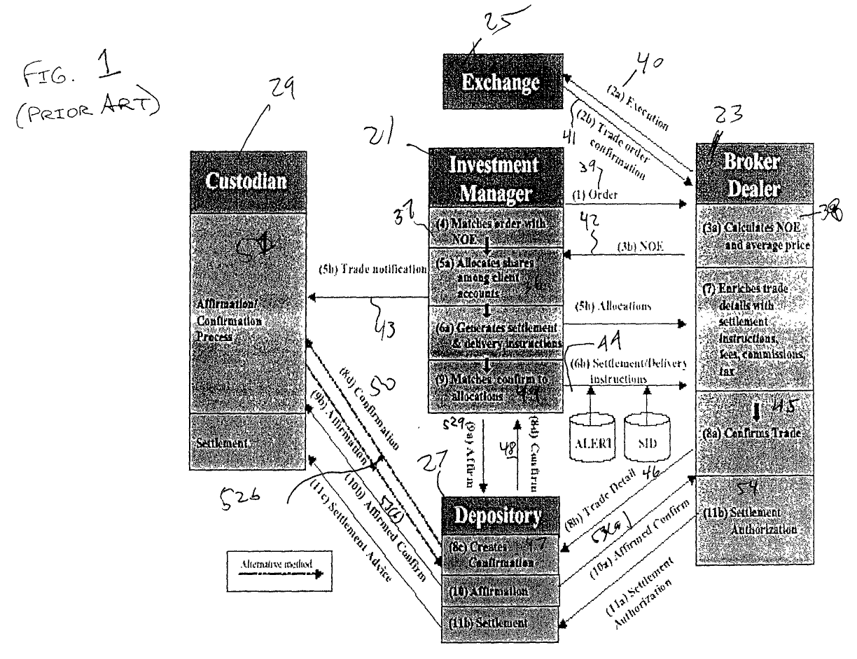

### DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. It should be noted that those individuals skilled in the art may be able to make some modifications of the preferred embodiments but which are based upon the underlying teachings contained within this subject invention.

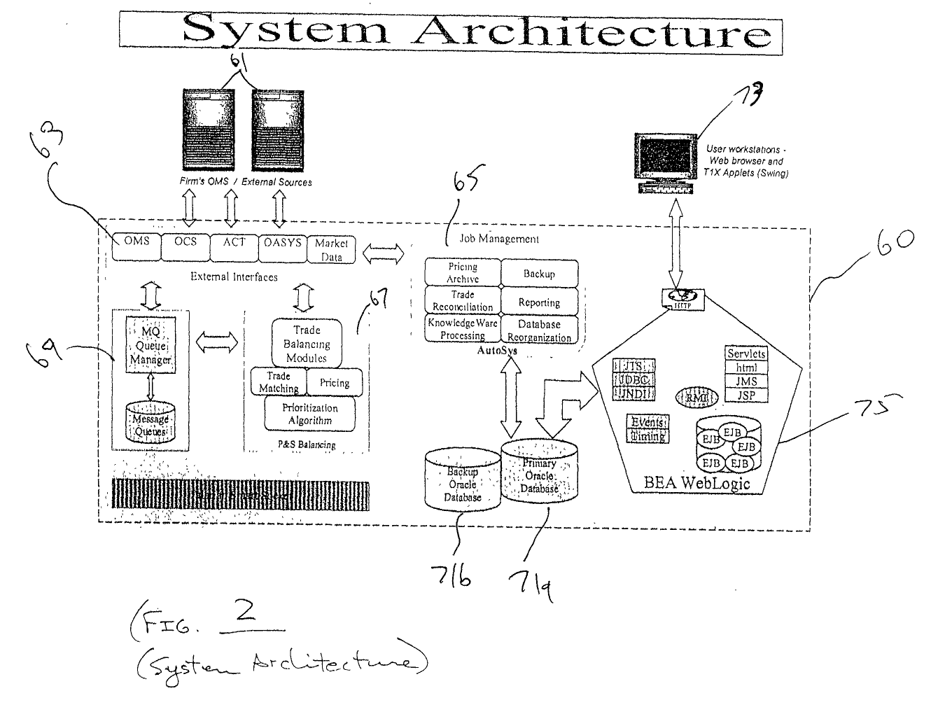

An overview of the preferred system architecture in accordance with the present invention is depicted in FIG. 2. Shown is Middle Office Balancing System 60 which depicts the exchange of trade information between Finn Order Management System (“OMS”) and/or External Sources 61 and external interfaces 63 in Middle Office Balancing System 60. Within Middle Office Balancing System 60, the trade information from OMS, OCS, ACT, OASYS and other market data interacts with job management module 65, P&S balancing module 67 and messaging module 69. Messaging module 69 queues the data and prepares messages with respect to the trade information received from OMS and/or external sources 61 and interacts with P&S balancing module 67. In turn, P&S balancing module 67 balances the trade information, matches trades and executions and prioritizes the trades for allocation and exception identification purposes. Still referring to FIG. 2, job management module 65 reconciles the trade information received from external interfaces 63 and performs administrative functions such as archiving prices, backing up information, reporting information and database recognition. Job management module 65 processes the information by interacting with primary database 71a, which stores, sorts and retrieves the trade information. Backup database 72b is connected to the system in order to ensure the important data in primary database 71a is never lost. In the preferred embodiment, primary database 71a and backup database 72b are, for example, Oracle databases, although alternatively any database which meets the requirements of the system can be used.

Still referring to FIG. 2, Middle Office Balancing System 60 interacts with user workstations 73 through browser system 75. As shown, browser system 75 comprises of several programs compatible with the hypertext transfer protocol to allow users to access Middle Office Balancing System 60. Examples of such programs include, but are not limited to: servlets, html, JMS, XML, JSP, etc. Together with Middle Office Balancing System 60, browser system 75 includes the software necessary for a user to interface the data captured and processed in database 71a via an interactive graphical user interface (“GUI”). The data are presented to the user in a prioritized sequence allowing the user to act upon them and take any necessary actions. The results of these actions are then processed back into Middle Office Balancing System 60.

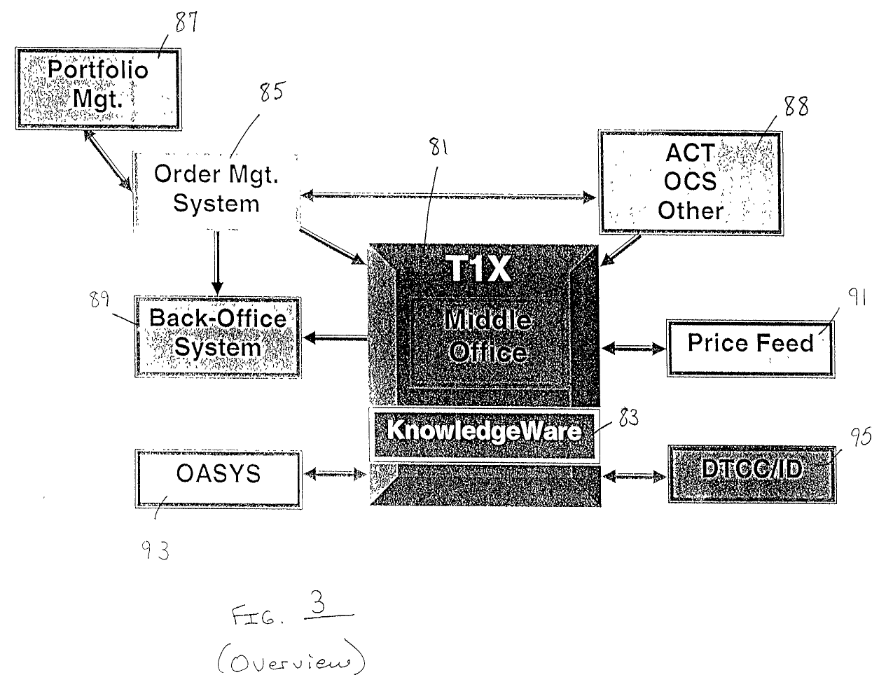

The present invention is adaptable to work with existing brokerage house systems. Referring next to FIG. 3, shown is an overview of the positioning of the MRTB according to the present invention within a typical existing system. Specifically, shown is Middle Office 81, containing processor 83. Middle Office 81 receives all of the data from various outside systems and then matches the data to determine if any exceptions exist. If any exceptions exist, that data is transmitted to processor 83 which prioritizes them based upon user defined criteria which are translated into Middle Office 81 algorithms for processing purposes.

Outside client portfolio management system 87 transmits orders to client order management system 85. Client order management system 85 transmits these orders to be processed on exchanges (not shown). Client order management system 85 also sends a copy of each order to Middle Office 81. When executions are received, client order management system 85 sends copies of this information back to outside client portfolio management system 87 and Middle Office 81. ACT, OCS or other exchange clearance systems 88 send execution information required for clearance to Middle Office 81 and to client order management system 85. Middle Office 81 interacts with Price Feeds 91 to determine market risk characteristics of exception trades. Such market characteristics include price movements, trading imbalances, and volume spikes. These values are processed by Middle Office 81 and used by processor 83 for risk determination. Middle Office 81 also receives customer driven allocations information from OASYS 93 and DTCC/ID 95 and uses the customer driven allocations in the balancing and exception processing. When the trades are balanced and ready to be processed, Middle Office 81 transmits the transaction data to client back office 89 for batch processing.

The securities industry and its transaction processing software suppliers have not been able to adequately solve the problems associated with real-time risk management that will arise when the T+1 cycle is implemented. The present invention incorporates complex real-time risk management features which are a breakthrough in the way in which securities are processed. The present invention's ability to handle exceptions allows the middle office personnel to focus only on any existing problems rather than focusing on every trade. Thus only breaks (i.e., out-of-balance transactions) are even shown to the operators.

It is the analysis of risk-allocation coupled with the rule based monitoring which allows an intelligent handling of the exceptions. The biggest problem facing the middle office personnel when adopting a T+1 cycle is the reconciliation of massive volumes of data before the end of the trade date. In the T+3 cycle, middle office personnel have over two days to reconcile the massive amounts of data, however in a T+1 cycle the reconciliation must be completed by the end of the trade date, or else expose the financial institution to absorption of the costs associated with unreconciled information, which is an enormous risk. The use of rule-based monitoring with analysis and prioritization of risk allocation systems highlights errors, and allows the clerk to focus on, and therefore remedy, the most severe issues first.

The Real-Time Middle-Office Balancing System is expressed in four functional blocks, namely, a Streetside Balancing System, a Customer Allocations Balancing System, a Real-time Sensitivity Analysis and a Real-time Work-in-process Flow.

The Streetside Balancing System (“SBS”) receives all information, such as trading activity, from the clearing broker or custodial bank. It captures the initial trade as well as all subsequent activity related to the initial trade. The SBS manages the real-time balancing of trade date and settlement date positions. The SBS balances NYSE executions vs. OCS, and NASD (National Association of Securities Dealers) executions vs. ACT (a system allowing comparison of over the counter trades) confirmations. This is necessary for effective T+1 processing.

The Customer Allocations Balancing System (“CABS”) verifies that all customer positions are allocated to customer accounts. CABS also verifies that the customer positions balance with streetside executions. CABS is therefore a necessary system for effectively adopting a T+1 processing cycle, by allowing the clearing institution to have real-time control over balancing activities.

By implementing CABS along with SBS, the present invention provides straight through transaction processing and real-time balancing for all services, and additional work flow process control functions that are unavailable in existing systems. The addition of automated workflow processes gives a financial institution the ability to monitor the effectiveness of firm policy in real-time and to react to changes in conditions in real-time.

Real-time Sensitivity Analysis allows the present invention to prioritize transaction processing and balancing, and to monitor the work flow. By prioritizing transaction processing and balancing, the present invention provides early warning of potential fails. By monitoring the work flow, the present invention provides a system of correcting potential fails in real time.

Real-time Work-in-process Flow and dynamic updating of the Real-time Sensitivity Analysis are based upon actual work processes. This allows the present invention to gather information from previous workflows and then update the rules that define out-of-balance conditions automatically. In essence, the present invention learns from all previous activity, and alerts the user when present information falls out of the normal range of activity.

The present invention includes a Risk Management System (“RMS”) to provide an additional layer of advanced risk management to the Middle-Office Balancing System which is the core transaction processing system.

Real-time monitoring of customer margins and the cage (the brokerage function that accepts payments and delivers securities) permit the aggregation of open positions and analysis thereof to determine the cumulative risk carried by both the firm and by customers in real-time. The RMS initially monitors firm positions (either market maker or principle positions) and compares them with allowable limits by accumulating all open positions and analyzing the cumulative risk to determine when the firm itself is carrying too much risk (i.e., when the firm will have to cover open positions if left unsettled). The system warns the manager when there is an unacceptable position. Typical circumstances which define an unacceptable position include, but are not limited to: undue concentration in position or combination of positions and overhang in securities in terms of time needed to unload positions. This function utilizes risk metrics gathered in the real-time P&S balancing function together with concentration metrics.

The present invention can also improve interactions on an individual stock and portfolio basis. The system calculates and monitors customer risk, including changes in risk characteristics (such as beta), and generates real-time value-at-risk (VAR) calculations. The system also provides tools for managing credit risk by monitoring real-time changes in maintenance margin requirements.

The compliance system monitors customer trading information and compares it against set compliance guidelines in real-time. The compliance system monitors several areas, including but not limited to: customer trading vs. trading objectives and irregular activity within a branch or a product line. Thus, the present invention can identify customer trading patterns to generate additional revenue, and offer a user the opportunity to enhance and optimize its business opportunities.

The system relies on a constant stream of data flow from the TFM systems that are being supplied by Omgeo and GSTPA (i.e., (publicly available industry utilities). In the unlikely event that the introduction of TFM information is interrupted or seriously delayed, the system would provide its own mini TFM by building custom interfaces to each of its customers' counter parties to collect order data flow.

As described above, the system preferably consists of three components, namely, the Middle-Office Real-Time Balancing System, the Risk Management System and the Compliance Management System. For the purposes of describing the system architecture, the risk management and compliance management systems will be treated as one system. Multiple Real Time Balancing preferably contains three components, namely, post-trade processing, a rule-based engine and an infrastructure.

The post-trade processing component captures all trading activity from the OMS application, manages the real-time balancing of trade date and settlement date positions, and verifies that all customer positions are allocated and that they balance to the street side information.

Importantly, the post-trade processing component has the ability to process street side trade breaks in real time. Currently the New York Stock Exchange distributes OCS information in real-time. Although institutions can currently continue to use the outdated overnight system, the NYSE will require intra-day processing before implementing the T+1 cycle. Similarly, NASD trades are compared on ACT. This process will be automated shortly as well. The rule-based engine of the present invention allows for the automation and optimization of the work such that the present invention can facilitate distribution of the work in the most efficient manner.

The present invention constantly receives execution information from the broker in real time while simultaneously receiving trade comparisons from OCS and ACT. If the trade comparison results in a confirmed match, the system processes the trade as compared. If there is an “out” (i.e., an unmatched execution) the system evaluates the nature of the out. By evaluating the nature of the out, the present invention can then decide, based upon work experience and quantitative measures, the odds of getting the out resolved within a specified time frame. Based upon these calculations, the system can then parse the work out to the proper personnel in the optimal configuration.

The present invention also compares the street side trade information to the customer-side trade information. The present invention ensures that the information relating to the customer-side of the trade compares with the information relating the street side of the trade, and then balances customer allocations with any outstanding street side information. This method of balancing is not performed by any existing system. As before, any outs are monitored by the system and the rule-based engine then applies the statistical measures and work-in-process analysis to decide the proper level of attention which the out requires.

Next, the rule-based engine provides the rules for analyzing routing, allocation and alert conditions. The allocation process uses the rule engine to control global allocation and specific allocation for block trading. Alert notification rules determine which execution and market conditions warrant alerts.

Last, the infrastructure comprises messaging features, a database and input and output feeds. The messaging features allow the different processes to communicate to ensure high performance and throughput. The preferable middleware is IBM MQSeries: Request/Reply and Publish/Subscribe. The preferable messaging format is Extend Markup Language (XML). The preferable relational database is Oracle due to its scalability and stability. Alternative embodiments of the present invention use alternative middleware and messaging formats which meet the minimum requirements of the system. The system can process several external feeds depending upon the vendors that the client is using. This choice includes, without limitation, Pricing and Position. Pricing refers to any of the Consolidated feed vendors and Level II NASD feeds, and Position refers to Customer Position records in any format. Order data can be accepted in FIX, CMS or customer defined, but FIX is the preferred format.

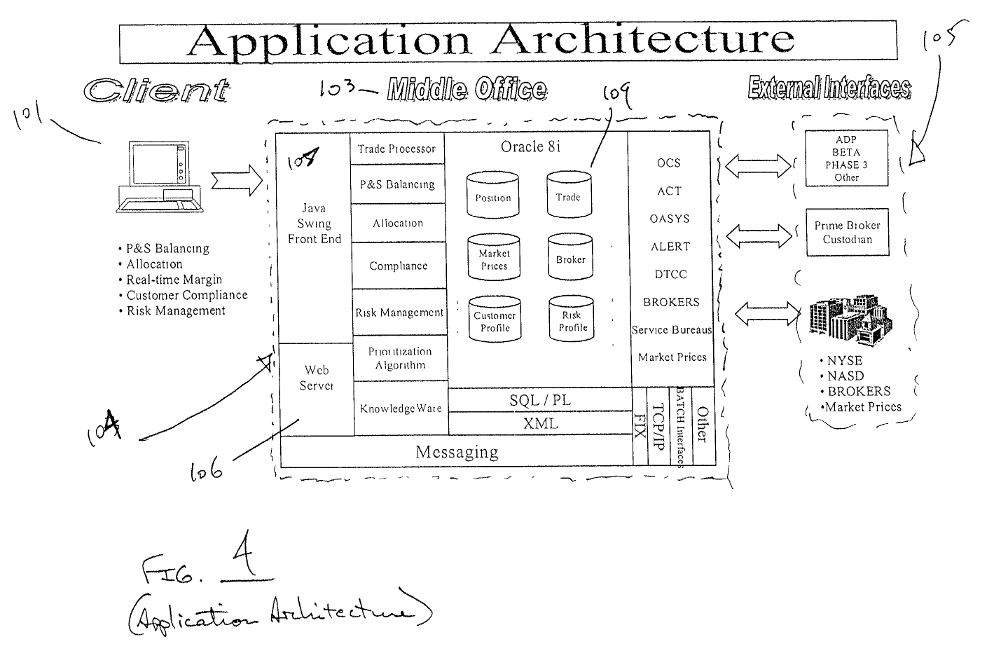

Referring next to FIG. 4, shown is the application architecture of the preferred embodiment of the MRTB system according to the present invention. Shown is client 101 which comprises the capability to handle, among other tasks, trade information for P&S balancing, allocation, real-time margin calculation, customer compliance and calculation and assignment of risk for risk management purposes. Client 101 shares information with middle office 103, which, in turn, interacts with external interfaces 105. Examples of such external interfaces are ADP, BETA, PHASE 3, brokers, custodians and exchanges such as NYSE, NASD.

Middle office 103 and client 101 interact via front end 107, an application sever preferably programmed in Java, but alternatively any user-friendly programming language may be used. Through front end 107, client 101 can transmit the information necessary for middle office 103 which processes the trade, confirms the allocations, and prioritizes any unconfirmed exceptions to manage the firm's risk. Middle Office 103 also ensures compliance with necessary SEC regulations. Middle Office 103 preferably contains databases 109 to track information relating to position, trades, market prices, brokers, customers, risk profiles and other similar categories. The server interacting with databases 109 is preferably an SQL server programmed with a user friendly programming language such as XML. The information can then be transmitted and exchanged with external interfaces 105.

To ensure security of the highest order, front end 107 will preferably reside behind firewall 104, and web server 106 will preferably reside outside the Firewall. User functions are preferably browser based, and may include, but are not limited to, Trade Inquiry, Alert, Account Monitoring, Customer Position Monitoring, Firm Position Monitoring and Ad-Hoc Reporting.

The system will have several clearance interfaces to interact with the external world, including, but not limited to, prime broker, custodial banks, and the Depository Trust Clearing Corporation. The preferred format is FIX, although TCP/IP, SNA and others can be utilized. The underlying architecture for the risk and compliance system comprises a rule based system using a decision tree module linked to a neural network to allow dynamic feedback.

T1X-MPA, a preferred message processing application, is an N-tier client-server based system, based upon Microsoft Windows/NT, Solaris/UNIX and Oracle. The system is preferably used with the present invention because it is secure, fault tolerant and can be scaled to meet most organizations' performance requirements. Alternatively, other message processing applications that meet the system requirements can be used. T1X-MPA can be broken down into the Trade Processing Analytic (TPA) server, which resides in a cluster, and a Symmetric Multi Process (SMP) platform. These components interact with each other to provide the functionality to the Middle Office users.

The TPA Server is comprised of a number of multi-threaded UNIX processes written in C++ or any alternative processes capable of providing high performance trade enrichment, routing and workflow management with real-time monitoring.

The Messaging Server is preferably based on IBM MQSeries version 5.1, the market-leading middleware messaging. Both the conventional ‘Request/Reply’ model and the ‘Publish/Subscribe’ model of the MQSeries can be used within the queuing infrastructure of the present invention. Preferably, the messaging format is XML. Conversion routines can be written for legacy interfaces.

The selected relational database is preferably Oracle 8i within the technology environment, used by the application for storing and recovering transactions. The database can store trade data (i.e., blocks, executions, and allocations), track the state of entities and route messages that affect those entities, house all information processed by TPA, including alerts, problem diagnosis and user and customer profile, and store configuration parameters for each interface (e.g. XML field tags, INTACT field tags, user view preference).

The user interface is preferably a Java-based GU that uses the Java Runtime Engine (JRE) v2.0, which is packaged with Internet Explorer 5 (or higher). The user interface communicates only with the Application server, preferably Weblogic v4.5, where the business rules reside.

The web-server is preferably a Netscape web-server for launching the User and Administrator interfaces and distributing web applets.

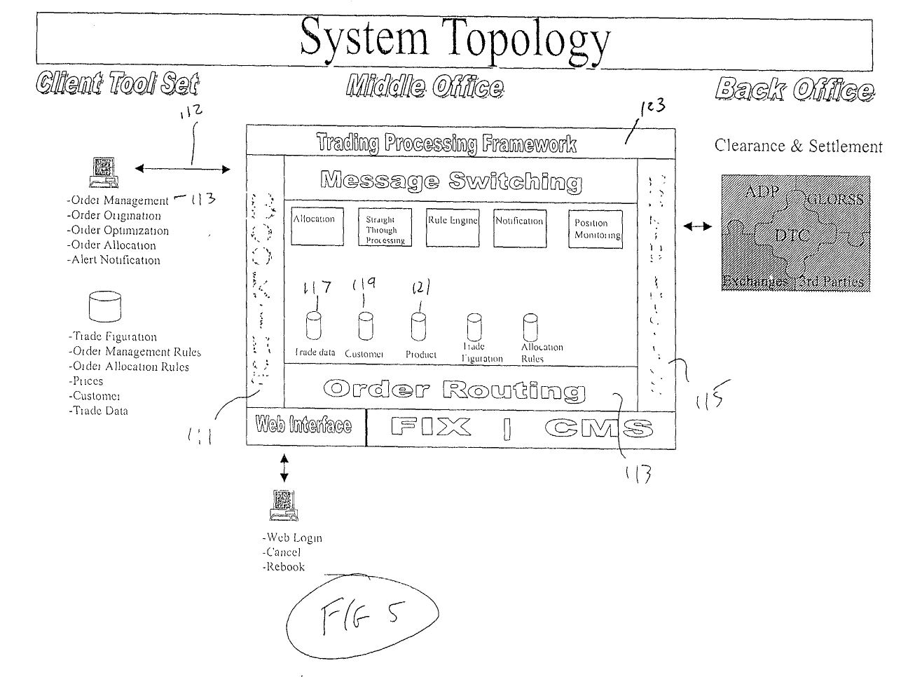

Referring next to FIG. 5, shown is the real time middle office balancing functional system topology, which details the functional requirements for the Middle Office section of the System Topology diagram and the processes that go on within each function of middle office processing. More importantly, it details the inter-relationships between the various functions. Client-side booking interface 111 processes orders from order management software 113. Clearance-side booking interface 115 processes executed trades that are received from external systems. Although the two booking interfaces are separate functions, and from a formal system flow may actually reside as distinct processes, from a user functionality vantage point they both bring orders and executed trades into the middle office for further processing.

The following is an example of how the Order Interface Module functions and interacts with the various modules in the middle office. Trading Processing Framework 123 receives orders from Front Office Module 113. Order Interface Module 112 receives the order, validates it, routes it along and logs the order.

Trading Processing Framework 123 receives an order and logs it to Trade Data Database 117. The message received from Front Office Module 113 must be stored in its entirety and logged with appropriate time stamps. Even if the order is subsequently rejected, the original message must be retained and logged in Trade Data Database 117.

Once the order is received and logged into the system, the order must be validated. Validation is a measure of internal consistency, i.e., does the format of the order make sense? The order is validated by comparing the information contained in it to customer data database 119. In alternative embodiments, the system may check the information against real time market price feeds and customer position feeds if these are supplied.

During validation, the comparison to information contained within customer data database 119 confirms that the customer attempting to trade the instruments contained in the order is authorized to execute those trades. It also validates that the customer is authorized to trade with either the broker or exchanges specified on the order.

In alternative embodiments, the customer can supply a position feed. In this embodiment, the system can verify the logical consistency between the size of the order and a sell. The system can also verify in the case of a sell that the customer has executed that position. Additionally, market price feeds can be used to verify whether the transaction is within predetermined parameters for consistency. For example, if a customer issues a sell for a security at $100.25, and the security is currently trading at $10.25, the system can automatically reject the sell as out of the predetermined parameter for consistency.

Order Allocation is the process by which the client allocates executed orders to specific accounts. There are two common methods for allocation currently used, namely global and specific allocation methods. Global order allocation allows a user to allocate an entire portfolio at once. The user allocates on a percentage basis thereby giving each specified sub-account a specific proportion of the total executed trades. There are two ways in which this is commonly done, proportional and specific. The first uses a pure proportion allocation. Under this method, the 10,000 shares of XYZ is proportioned to the sub-accounts at 50%, 20% and 30% respectively. If the entire amount is not executed then the executed amount is allocated in those percentages. In this case, there are rules for rounding. For example, if allocating the proper percentage of shares leaves a fractional amount, or if the portfolios are not allowed to have less than 10 or 100 share lots, the portfolios would be adjusted accordingly.

Specific allocation allows a user to access each total executed amount and then allocate the proper quantity of shares to each sub account. This can be done manually by having the user inspect each execution and then allocate each trade to its proper sub account. Alternatively, the user can feed in a file which has specific allocations and match those against the executions.

The ensuing sections describe the functionality of the present invention from the custodial and prime broker perspectives. It is important to remember that the perspectives of the prime broker and custodian begin only after the trade has been executed. Therefore, from the systems point of view, it is irrelevant what the customer front end is, so long as it communicates with the middleware of the invention.

Trade notification is the first step in the processing loop for the custodian. The custodian must first receive each execution. The custodian also must receive an identification key within the trade notification that allows the custodian to identify that trade execution as part of a larger group belonging to a specific sub account grouping.

The Rule Based Engine assists the custodians and prime brokers in managing the clearance function and risk management function. Although these are two mutually exclusive functions, they are interrelated because clearance alarms essentially outline the risks which require risk management.

Each custodian and prime broker can set up generic “house” rules as well as customer specific rules. “House” rules are the overriding business rules that determine clearance procedures. For example, the system would check if the major account has sub accounts to which trades can be allocated; the system has specific rules for first time accounts; and time dependent clearing rules.

Customer specific rules are those that detail practices for each specific customer. For example, the system can have dollar alarms (i.e., how much expected volume should there be for a client on any given day); the system can recognize patterns (i.e., whether today's trading looks like yesterdays or does it seem like a brand-new list of trades); as well as time constraints for processing specific clients; etc.

Risk management rules measure the amount of clearance risk that the custodian or prime brokers is willing to carry. This risk can be measured both on a client-by-client basis and on a firm wide basis. The firm can set different alarm limits for each customer based upon creditworthiness. The firm can also have enterprise wide capital limits that would ensure that an override cannot be exceeded by customer limits. It can also proscribe limits for any specific security. Based upon the combination of alarms, different levels of alerts would be issued to specified personnel in the firm.

The Rule System utilized in the present invention consists of two basic components. The first component is a traditional rules table that consists of a series of decision trees that drive the actions of the system. The second component is a feedback mechanism that allows the sampling of data to influence the rules and to warn users when the suppositions behind the rules are shifting.

The Rule System processes both external and internal inputs and uses those inputs to evaluate the current state of events. The Rule System tracks, for example, the status of trades (i.e., allocated vs. unallocated), the types of orders sent through the system (i.e., size of orders, types of orders), and the securities that are being traded. The system then compares the events being tracked to historic and real-time data to determine whether the rules are being followed. The system can then highlight exception conditions. The system preferably looks at the following types of data for comparison purposes: historic volume data, average trade size for security and client, historic volatility and news events.

The system uses the data to evaluate whether the profile of the activity being tracked deviates from expected parameters. Therefore, if volume is normally N and the client typically does not trade this stock and the client is now a percentage of N, the system will trigger an alarm. Similarly if the client typically trades a stock with certain characteristics, but those characteristics are changing such that client or firm exposure rises above risk adjusted Y, then the system would create an alarm.

The present invention analyzes and manages operational risk in securities brokerage operations. All exception conditions are defined as discrete occurrences of events. The system operates by analyzing events within the operations of the brokerage firm and breaking them down into operative conditions and assigning priorities to them. The interaction of these conditions creates a hierarchy of priorities. The system then analyzes the priority list and assigns, on the basis of priority, work load to the proper personnel based upon clerk availability and skill levels.

The system also has a feed back mechanism so that priority assignation is compared with the workload assignation. Therefore, if a clerk overrides the priority of the system, this event is noted and fed back into the system to fine tune the algorithm.

The algorithm is based upon defining relationships between events and assigning relative weights to each exception event. Each event is assigned a priority as described above. A priority can be divided into 3 parts: that is, HIGH, MEDIUM, and LOW which may be numerically valued 3, 2 and 1, respectively. Based on the weighting factors from the database (preferably an Oracle database), the priority for each exception caught has to be determined. To do so, a point-score has to be measured for each exception. Higher point-scores indicate higher priorities. The preferred formula for getting the point-score is:

Point-Score=Sum (priority for each weighting factor),

The weighting factor(s) are each independently defined and evaluated. Then, the sum total of the weighting factors produces the point score.

For example, assume that the database has the N number of weighting factors. The highest point-score will be:

Highest Point-Score=N*3,

where N is the number of factors and 3 is the numeric value for the HIGH priority. If N=10, then the highest point-score is 30. Consider a situation where 3 exceptions are caught with point-score of:

Exception #1: Point-Score=5

Exception #2: Point-Score=15

Exception #3: Point-Score=25.

Then, the priority for the above Exceptions are determined to be LOW, MEDIUM, and HIGH respectively, where the range of HIGH, MEDIUM, and LOW is 1-10, 11-20, 21-30 respectively, for this situation, and is defined somewhere in the priority class. Although the range is evenly distributed, different ranges can be defined if desired.

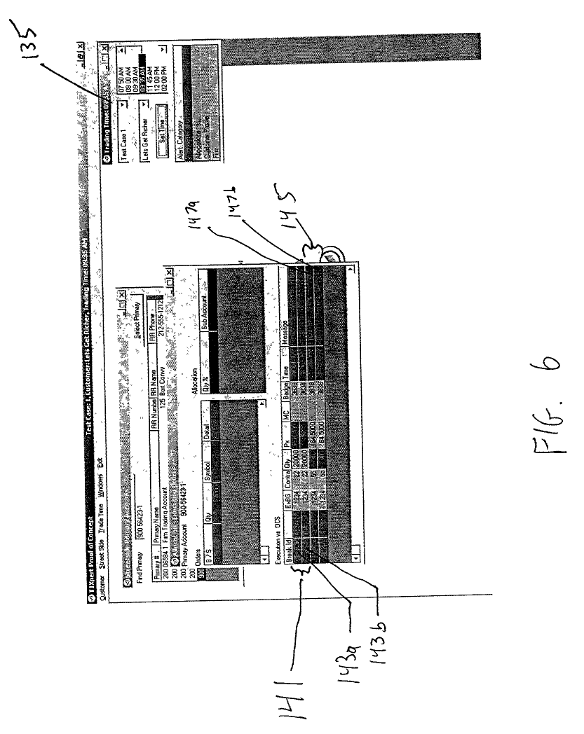

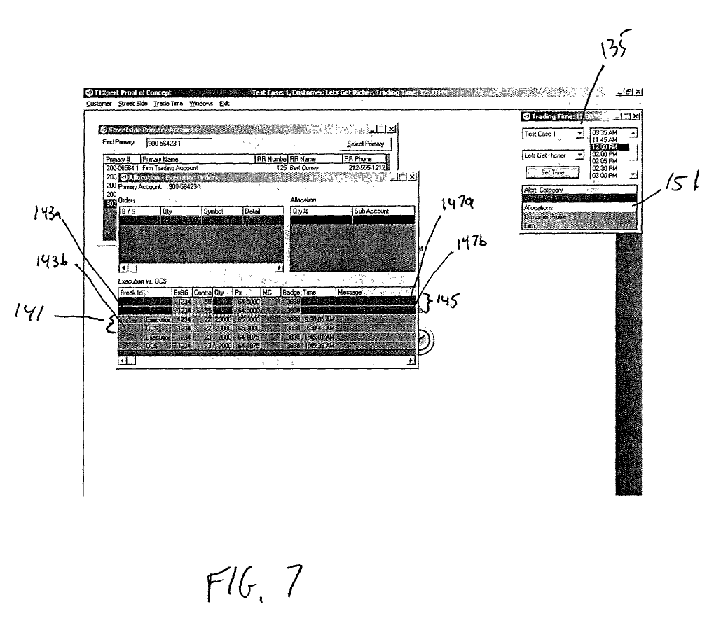

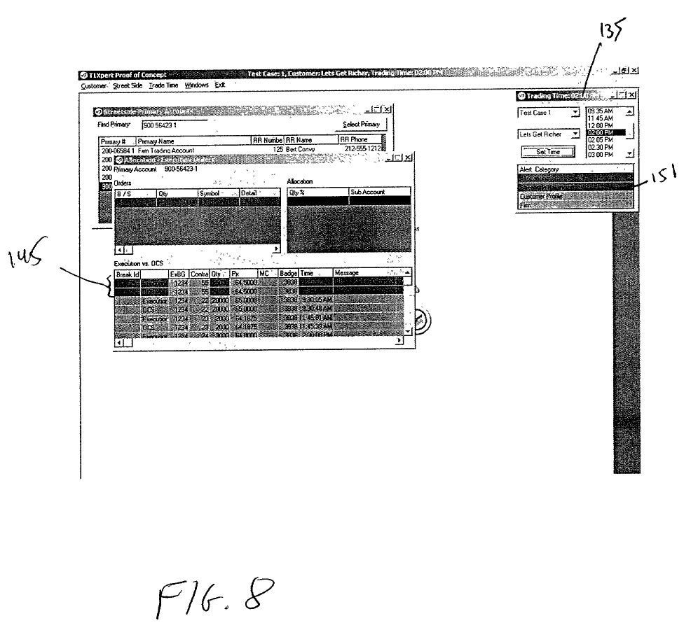

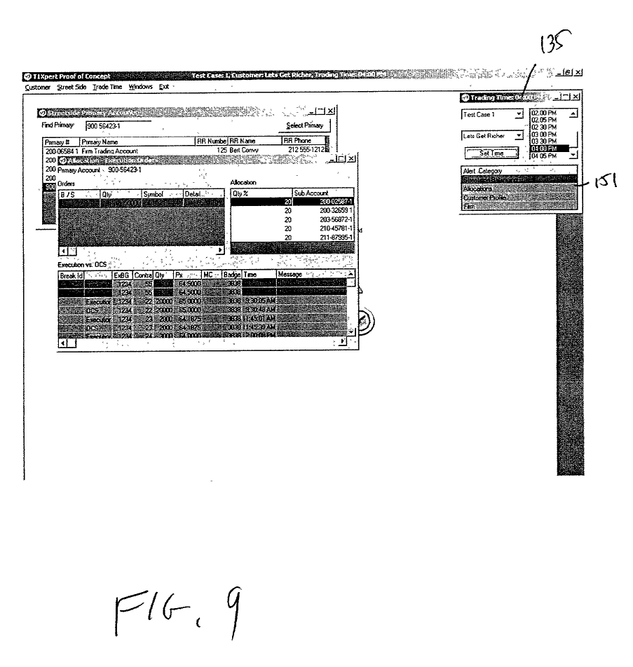

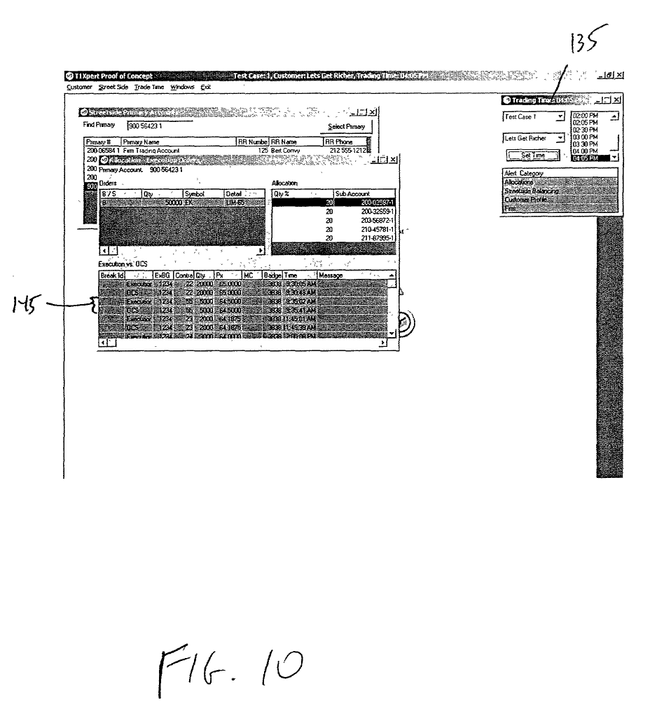

Referring now to FIG. 6, shown is the priority ranking procedure to determine the workflow priority of each item. The work is ranked according to the priority of each item. A clerk is shown a list of identified work requiring completion. If the clerk does not choose the work items possessing the highest priorities, then the system recognizes that the clerk has overridden the system. This causes an exception condition to be noted that is stored in the database. These exceptions are then analyzed to determine if the manual override should be reflected in the weighting of the algorithm. In this way the algorithm is constantly refined over time.

The following describes the specific application of P&S. There are two unique features to the system's P&S Application: three legged balancing and the use of the priority ranking procedure.

The present invention differs from traditional P&S balancing systems in that it balances, in real time, all three segments of a trade. Trades have three “legs”. The brokerage firm receives an order from a customer, it gives the order to the trading desk, and the trading desk, in turn, executes the trade with a contra party.

Typically, traditional P&S systems balance the customer trade allocation to the firm's order management system. The firm can also balance the order desk's ticket to the floor report. Currently, the floor report is never matched to the customer allocation until the following day. The present invention completes the balancing of all three legs intra-day.

The cases described herein concentrate on NYSE trades. Although the mechanisms are slightly different for over the counter (“OTC”) trades, the processing logic remains the same. The system receives executed trades from the OMS, and these executions are then matched against the NYSE OCS. The present invention provides for floor execution reports as well.

Operating conditions that have been defined as exception conditions that the system must rank include: OMS execution with no Streetside matched transaction; Streetside matched execution with no OMS execution; Uncompared Only; Advisory Only; and Uncompared with Potential Matches.

There are two types of prioritization decision rules, namely the trump factor and the algorithm. The trump factor is an overriding threshold, which always governs the assignment of an item to the highest priority queue. The threshold is met without using an algorithm. Once an item is assigned a high priority the item maintains its ranking as high. The trump factors must be available to be viewed by the user. Examples of a trump factor include: any problem market value greater than X will be high; any OCS uncompared or advisory without corresponding OMS information will be placed in the high priority queue and ranked within the queue; and any OMS without matching information from OCS will be placed in the high priority queue and ranked within the queue. Thus, an OCS uncompared will automatically be ranked with a high ranking relative to other priority items. For example, a trump could carry a 100 point weight. The algorithm weight could also be 100 points. Therefore, the trump weight of 100 guarantees a high ranking since by definition 100 points is greater than the minimum high ranking. The relative positioning of one OCS uncompared to another is determined by adding the algorithm weight to the trump weight and then ranking by total weight.

The algorithm weight is the sum of the points assigned to an item by adding the sums of the various threshold categories (i.e. Time Threshold Weight plus Market Value Weight will determine the priority for that item.) Establishing a range of values to define a priority (i.e., High, Medium or Low) allows an item to stay ranked within the priority, once it has been ranked. For example, assuming arbitrarily that a “low” priority is defined as 0-30, “medium” priority is defined as 31-79, and “high” priority is defined as 80 and above. Two items that fall within the high priority range will be ranked relative to one another by summing their point value so that an item with a value of 82 is ranked with a lower priority within the high ranking than an item with a value of 90.

The “threshold” is defined as the conditions used by the applications to determine the priority of each individual exception. The client would first assign a number to each of the highest-level thresholds. (For example—age of problem.) A higher number signifies the relatively higher importance the client attaches to that threshold. The total of these numbers would equal 100. An example is illustrated in the following tables:

TABLE 1

| | | Weighting | |
|---|---|---|---|
| Threshold | Individual Items | Number | |
| Time Threshold | | | |
| Age of Problem— | | | 40 |
| amount of time | | | |
| elapsed since the | | | |
| item was received. | | | |
| | Prior to 2:00 pm any item 0-60 | 25% | |
| | minutes. | | |
| | 60-120 minutes equals. | 25% | |
| | 120+ minutes equals. | 25% | |
| | After 2:00 pm any item over 60 | 25% | |
| | minutes old. | | |
| Current Time— | | | N |
| The current time of | | | |
| day determines the | | | |
| priority as deter- | | | |
| mined by the user. | | | |
| | The open until noon. | | |
| | From 12:01 pm until 2:00 pm. | | |
| | From 2:00 pm until the close. | | |
| Market Threshold | | | |
| Problem Market | | | N |
| Value—The current | | | |
| value of the problem | | | |
| as determined by | | | |
| mark to the market. | | | |
| | If the current price is 10% or | | |
| | greater than the execution price the | | |
| | exception is rated high. | | |
| | If the current price is 9.9% to 5% | | |
| | greater than the execution price the | | |
| | exception is rated medium. | | |
| | If the current price is 4.9% to 0% | | |
| | greater than the execution price the | | |
| | exception is rated low. | | |
| Volatility—Today's | | | N |
| opening price versus | | | |
| the current mark. | | | |
| The mark will be | | | |
| done hourly with | | | |
| any variance: | | | |
| | Greater than 10% equals high. | | |
| | 9.9% to 5% equals medium. | | |
| | 4.9% to 0% equals low. | | |
| Liquidity | | | N |
| | Percentages of daily trading volume: | | |
| | This is a user set parameter, until we | | |
| | start running InSyst we have no way | | |
| | of giving intelligent parameters here | | |
| | and we will let the user pick. | | |
| | Example—If the client's position is | | |
| | 5% or greater of the daily volume | | |
| | this would rate a high priority. | | |
| | If the client's position were 1.1% to | | |
| | 4.9% of the daily volume this would | | |
| | rate a medium priority. | | |
| | If the client's position is 1% or less | | |
| | of the daily volume this would rate | | |
| | a low priority. | | |
| | Velocity of price change: This would | | |
| | be a user set parameter. If the price | | |
| | moves X in wrong direction within Y | | |
| | minutes. Example— | | |
| | If the price moves 5% off the open in | | |
| | 10 minutes this would rate a high | | |
| | priority. | | |
| | If the price moves 5% off the open in | | |
| | 180 minutes this would rate a | | |
| | medium priority. | | |
| | If the price moves 5% off the open in | | |
| | 5 hours this would rate a low | | |
| | priority. | | |
| | Current Market Price: If the price is | | |
| | in your favor then the item it not as | | |
| | “hot” as one that is against you. | | |
| | Ranking would start with those | | |
| | furthest against you becoming the | | |
| | highest in work prioritization. | | |
| | Example— | | |
| | The top one third of those prices | | |
| | furthest against you would rate a | | |
| | high priority. The middle one third of | | |
| | those prices furthest against you | | |
| | would rate a medium priority. The | | |
| | bottom one third of those prices | | |
| | furthest against you would rate a low | | |
| | priority. | | |
| Spread Size | | | |
| Bid/Ask Spread | | | |
| Account Threshold | | | |
| Size of Order— | | | N |
| Based on historical | | | |
| activity (90 days) | | | |
| orders which are: | | | |
| | Greater than a factor of 5 equal | | |
| | high. | | |
| | From a factor of 3 to 5 equal | | |
| | medium. | | |
| | From a factor of 0 to 2.9 equal low. | | |
| Allocations | | | N |
| | If determined to be an allocatable | | |
| | trade than the priority is high all | | |
| | others are low. | | |
| Customer Identity | | | N |
| | Level of Business—80% of a firm's | | |
| | revenue is derived from 20% of its | | |
| | customers. If the client can be | | |
| | identified as one of the 20% the item | | |
| | would be a high priority. All others | | |
| | would be low. | | |
| | Important Customer—Clients would | | |
| | be rated regardless of revenue; this | | |
| | provides a level playing field for | | |
| | potential revenue producing clients. | | |
| | The rating would be assigned as | | |
| | high, medium or low by the assigned | | |
| | sales/trader as based on a bell curve. | | |
| | Interested Party * | | |
| | Level of Commissions | | |
| Broker Threshold | | | |
| Contra Broker | The # of exceptions with a contra | | N |
| Identity | broker as a percent of total trades | | |
| | done cumulatively. | | |
| | 5% or more problems monthly | | |
| | equal high. | | |
| | 3% to 4% problems monthly equal | | |
| | medium. | | |
| | 1% to 2% problems monthly equal | | |
| | low. | | |
| Minor Badge | The number of exceptions with a | | N |
| | minor badge as a percent of total | | |
| | trades done cumulatively. | | |
| | 5% or more problems monthly | | |
| | equal high. | | |
| | 3% to 4% problems monthly equal | | |
| | medium. | | |
| | 3.1% to 2% problems | | |
| | monthly equal low. | | |
| AE Identity * | | | |
| Borrow/Loan | | | |
| Possibilities * | | | |
| Fail Profile * | | | |

Then, within the threshold the individual items would become benchmarks. In other words, as the thresholds were met, that percentage of the total number would then apply. For example, if “age of problem” is assigned the number 40, as each of the four sub items are met another 25% of 40 is applied to the total, thereby determining the priority based on the total numerical score.

High=80 to 100 points

Medium=31 to 79 points

Low=0 to 30 points

Of course, weighting may be changed continuously and new classes and thresholds may be added off line.

When a number of exceptions occur within one parameter, or when a security that would cause a “cluster” relationship occurs, it is termed a “cluster effect.” The triggering of a cluster occurs because the accumulation of similar problems, although each one is individually small, adds up in aggregate to exceed the allowable threshold. This could be a user defined threshold trump possibly based on a dollar value or number of tickets. The triggering of a trump could be automatic because the aggregation is, by definition, a problem or a warning to a supervisor to look at and assign, if necessary, an override rating.

The following are examples of aggregations and why they would have to be looked at.

Automatic Trumps:

Broker other side (“BOS”): If all trades with a particular BOS are not being acknowledged then there could be a system problem on the other side and the other side should be alerted in order to correct the problem.

Stock: If a particular security is not being acknowledged and the aggregate dollar amount at risk is large, the problem should be flagged and corrected.

$2 Broker: If a particular $2 broker is not reporting their trade executions, then this could be a problem the broker is having with BBSS (the NYSE system used by $2 brokers to report their executions to accounts) or staffing.

Fielder's Choice:

These clusters trigger an alert to let the manager decide whether he wants to change the priority of these items.

Client: A particular client has a number of problem trades that warrant attention before other similar priority or higher priority items. This designation depends upon identity of client, dollar value and other factors. In addition, if a client has not sent in allocations for a program, that may warrant a promotion to top priority.

Process Control

The following examples lay out various scenarios that illustrate the process control of the present invention to demonstrate that the present invention used in conjunction with certain existing systems can create a complete T+1 real-time balancing and process control system. The examples focus on illustrating the risk management and process controls by simultaneously examining the customer side, the execution side and the streetside processes of a transaction. Initially, the situations we will illustrate are outlined, and then, the types of databases preferred for use in the present invention are detailed.

Turning now to FIG. 7a, depicted is an example of streetside real-time P&S balancing by simulating executions and real-time OCS and ACT reporting. That is, shown is an embodiment of a computer screen as it would be seen by someone using the present invention. Specifically, FIG. 7a is a snapshot of the constantly changing screen at 9:35 AM. Status 135 contains alert categories labeled “Streetside Balancing,” “Allocations,” “Customer Profile” and “Firm.” At approximately 9:35 AM the allocations, customer profile and firm alerts are green, signifying no exceptions. However, status 135 displays the streetside balancing alert category in red, signifying at least one exception. Also depicted in FIG. 6 are two trades, both with exceptions. The system preferably shows different sensitivities of exceptions, shown as red and/or yellow alerts, depending upon factors such as time of day and customer. Here, trade 141 highlights an exception based on price. Trade 141 shows a trade executed at approximately 9:30 AM for 20,000 shares of EK, a specific security. Trade 141 consists of execution 143a and confirmation 143b. Execution 143a lists the price of the trade at $65.0000, while confirmation 143b lists the price at $65.1250. Because of this discrepancy in price, the price columns of trade 141 are highlighted in red, to alert the user that an exception exists there. The message column lists this disagreement in price between execution 143a and confirmation 143b. The quantity column and other columns containing accurately matched information are colored green to indicate their accuracy.

Still referring to FIG. 7a, depicted is trade 145, executed at approximately 9:35 AM, consisting of execution 147a and confirmation 147b. Here, execution 147a and confirmation 147b both list $64.5000 as the price, and therefore the price columns are green. However, the quantity column associated with trade 145 is red, due to a mismatch in quantity. Execution 147a lists a trade for 5000 shares of EK while confirmation 147b lists a trade for 4500 shares of EK. This mismatch causes the system to alert the user by displaying the quantity columns associated with trade 145 in red as depicted in FIG. 7a.

FIG. 7a demonstrates a lot of activity in a specific stock and some out of balance conditions between the streetside and OCS. It highlights examples of breaks between streetside and order. Different levels of alerts can be based upon simulated time, i.e., an OCS out of balance five minutes after the customer report is less serious than a report half an hour after the trade. In this example both conditions are red because the execution and OCS reports have both been reported and they differ as to price or quantity, which are factors deserving of red alerts. This example also shows the present invention's real-time capability, as trade 145 executed at approximately 9:35 AM, at approximately the same moment as this screen shot was taken. Therefore, the instant the present invention detects a mismatch of information, the present invention can highlight the exception in yellow or red for example, depending on the level of importance.

Referring now to FIG. 7b, depicted is an allocation screen similar to FIG. 7a, but this screen shot was taken at approximately 12:00 PM of the same day. As depicted, trade 141 has been resolved as 20,000 shares of EK at $65.000. Upon resolution of the exception, the trade has been highlighted in green. Trade 145 is still unresolved, as execution 147a still reads 5000 shares of EK at $64.5000 and confirmation 147b still reads 4500 shares at $64.5000. Therefore, trade 145 is still marked red. FIG.7 also depicts status 135, still displaying a red streetside balancing alert. However, allocation alert 151 is displayed here in yellow. The example shows that a late allocation by certain customers carries more weight if that late allocation does not fit their allocation profile. In other words, if typically a specific customer's allocation arrives X time period after he finishes trading, and X+Y% has gone by, the system will show an alert. In contrast, if another customer's allocation typically arrives later, then even though X+Y% time has passed, it may not be considered a late allocation; even if the two customers have the same market value at risk. Allocation alert 151 is yellow because the time is noon and no allocations have yet been reported. For this specific customer, that constitutes an alert, but not an exception that must be immediately acted upon. This customer frequently does not report allocations until a later time period, and therefore allocation alert 151 is yellow.

Turning next to FIG. 7c, depicted is an allocation screen similar to FIGS. 7a and 7b, but this screen shot was taken at approximately 2:00 PM of the same day. While further trades have been executed, no further exceptions have been detected, yet status 135 now displays allocation alert 151 in red. The passage of two hours without an allocation report from the client has changed allocation alert 151 to red since it is now after the expected time for allocations. The exception must now be dealt with or risk financial loss to the firm. Status 135 displays the streetside alert in red because trade 145 has still not been resolved.

Referring now to FIG. 7d, depicted is an allocation screen similar to FIGS. 7a, 7b and 7c, however this screen shot was taken at approximately 4:00 PM of the same day. Here, the allocation report has been submitted and the customer allocation matches the execution report. Therefore, status 135 now displays allocation alert 151 in green. However, there still is an out of balance between OCS and the execution report that requires resolution.

Referring finally to FIG. 7e, shown is an allocation screen similar to FIGS. 7a, 7b, 7c and 7d, however this screen shot was taken at approximately 4:05 PM of the same day. The exception associated with trade 145, namely a quantity discrepancy of 500 shares, has been resolved. Trade 145 has been executed as 5000 shares of EK at $64.5000. Status 135 now displays all alert symbols in green, signifying that all pieces are in agreement with one another and hence the transaction can be released for processing.

FIGS. 7a through 7e demonstrate only one benefit of multiple real time balancing of securities. Prior to the implementation of the present invention, exceptions could only be identified after running a report after the close of the market. Only then could an institution identify and solve problems associated with exceptions. The present invention allows institutions to identify and solve common problems during the trading day, thereby allowing compliance with a T+1 trading cycle as well as a reduction of the institution's risk. Of course, other benefits will be apparent to persons having ordinary skill in the art.

The databases and real-time data feeds of one embodiment of the present invention include, but are not limited to, the Customer Account Profile, Trade Database, OCS/ACT Comparison Database and Allocation Database.

The preferred information stored, compiled and utilized from the Customer Account Profile database is detailed in Table 2 below:

TABLE 2

| Field Name | Description |
|---|---|
| Customer Major | Identifies the customer at the highest level |
| Customer Minor | Sub-account |
| Account Name | Name of sub-account |

The trade database shows the entire activity surrounding each order. The data is contemplated to be divided into several tables, including but not limited to Order Table and Execution Table, samples of which are reproduced below as Tables 3-5:

TABLE 3
Order Table

| Field Name | Description |
|---|---|
| Customer Major | |
| Customer Minor | |
| Tag Number | Unique identifier for the order |
| Order Type | B/S/SS |
| Ticker | |
| Quantity | |
| Price | Market or Limit Price |
| Time entered | |
| Original Br/Seq | Original branch sequence number assigned by order |
| Number | match |
| Order Ack Time | Time original order acknowledged |

A subsidiary table to Order Table is a table that would track specific types of orders, such as cancels and replaces. One example of such a table is reproduced below:

TABLE 4
Order Table subsidiary

| Field Name | Description |
|---|---|
| Customer Major | |
| Customer Minor | |
| Tag Number | |
| Cancel/Replace | Cancel or replace order |
| Br/Seq | Br Seq of replace |
| Ack Time | Acknowledgement time |
| Replace quantity | |
| Replace Price | |
| Time Entered | |

The Execution Table tracks the execution of each piece of an order. A sample of such an execution table is reproduced below:

TABLE 5
Execution Table

| Field | Description |
|---|---|
| Customer Major | |
| Customer Minor | |
| Tag Number | |
| Execution Quantity | Amount Executed |
| Time of Execution | |
| Leaves | Amount left unexecuted |
| Br/Seq Number | Br Sequence number of execution |

The OCS/ACT comparison database simulates activity coming in from the NYSE and NASD. This table receives the real time streetside comparison data from the NYSE (OCS) or NASD (ACT). The OCS/ACT comparison database interfaces to these systems allowing the broker to acknowledge trades coming in and reject and/or correct transactions that do not agree with the broker's trade execution data.

TABLE 6
OCS/ACT Comparison Table

| Field Name | Description |
|---|---|
| Ticker Symbol | |
| Buy/Sell Indicator | B or S |
| Quantity | |
| Price | |
| Executing Broker | |
| Time of Execution | |
| Time of Acceptance | |

Finally, the Allocation Database consists of two tables: Allocation Total and Allocation Breakdown. Examples of each are reproduced below:

TABLE 7
Allocation Total Table

| Field Name | Description |
|---|---|
| Account Major | |
| Trade date | |
| Ticker Symbol | |
| Quantity | |
| Average price | |
| Allocation Tag Number | Unique number identifying each allocation and |
| | it's breakdowns. |

TABLE 8
Allocation Breakdown Table

| Field Name | Description |
|---|---|
| Account Major | |
| Allocation Tag Number | |
| Account Minor | Sub account to which allocation is being |
| | distributed. |
| Quantity | |

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A balancing system use with the financial markets, said system comprising:
a first booking interface for processing trade information received from clients;
a second booking interface for processing trade information received from external systems;
at least one database for storing and comparing information received by said first and second booking interfaces;
a processing interface for receiving said trade information from said first and second booking interfaces, logging said trade information into said database and validating said trade information;
wherein said processing interface compares said trade information from first booking interface to said trade information from said second booking interface; wherein said validating includes identifying unmatched pairs of said trade information; wherein said system provides an output identifying said unmatched pairs of said trade information; and wherein said balancing system functions in real time.

2. A system according to claim 1, wherein said system further comprises a database to store, sort and retrieve trade data.

3. A system according to claim 1, wherein said system further comprises a database to store, sort and retrieve customer information.

4. A system according to claim 1, wherein said system further comprises a database to store, sort and retrieve product information.

5. A system according to claim 1, wherein said system further comprises a database to store, sort and retrieve trade figuration.

6. A system according to claim 1, wherein said system further comprises a database to store, sort and retrieve allocation rules.

7. A system according to claim 1, wherein said system further comprises a messaging module to query said trade information, wherein said messaging module prepares messages with respect to said trade information.

8. A system according to claim 1, wherein one of said booking interfaces exchanges information with third parties.

9. A system according to claim 1, wherein one of said booking interfaces exchanges information with ADP.

10. A system according to claim 1, wherein one of said booking interfaces exchanges information with DTC.

11. A system according to claim 1, wherein one of said booking interfaces exchanges information with the exchanges.

12. A system according to claim 1, wherein said trading processing framework receives, logs and validates said trade information.

13. A system for balancing orders, executions and allocations associated with trading on the financial markets, said system comprising:
interfaces for receiving information from external sources;
balancing module for exchanging information with external interfaces;
at least one database for storing said information; and
a user interface to allow interaction with said system;
wherein said balancing module compares said information received from said database and said information received from said interfaces; wherein said balancing module identifies incompatible information; and wherein said system provides output through said user interface notifying a user of said incompatible information.

14. A system according to claim 13, wherein said interfaces further comprise secondary interfaces to exchange market data information from OMS, OCS, ACT, and OASYS.

15. A system according to claim 13, wherein said interfaces further comprise secondary interfaces to exchange market information with an outside firm's OMS.

16. A system according to claim 13, wherein said balancing module further comprises trade balancing modules for comparing price, quantity and allocation data from said information to identify said incompatible information.

17. A system according to claim 13, wherein said balancing module further comprises a prioritization algorithm to prioritize said incompatible information.

18. A system according to claim 13, wherein said system comprises a primary database for storing, sorting and retrieving said information and a secondary database used primarily for protection against loss of said information from said primary database.

19. A system according to claim 18, wherein said primary and secondary databases are relational or object oriented databases.

20. A system according to claim 13, wherein said system further comprises a trade data database for storing, sorting and retrieving trade information.

21. A system according to claim 13, wherein said system further comprises a customer data database for storing, sorting and retrieving customer information.

22. A system according to claim 13, wherein said system further comprises a product database for storing, sorting and retrieving securities information.

23. A system according to claim 13, wherein said system further comprises a trade figuration database for storing, sorting and retrieving trade figuration information.

24. A system according to claim 13, wherein said system further comprises an allocation rules database for storing, sorting and retrieving allocation rules for prioritization of said incompatible information.

25. A system according to claim 13, wherein said system further comprises a job management module for performing administrative functions.

26. A system according to claim 25, wherein said job management module further comprises a plurality of databases.

27. A system according to claim 25, wherein said job management module further comprises a pricing archive database for storing pricing information.

28. A system according to claim 25, wherein said job management module further comprises a trade reconciliation database for recording reconciled trades.

29. A system according to claim 25, wherein said job management module analyzes said information to determine the presence of said incompatible information.

30. A system according to claim 25, wherein said job management module further comprises a reporting database for generating reports.

31. A system according to claim 25, wherein said job management module further comprises a backup database.

32. A system according to claim 13, wherein said system further comprises a messaging module to query said trade information; wherein said messaging module prepares messages with respect to said trade information.

33. A system according to claim 13, wherein said user interface further comprises a browser system to allow a user to interact with said information and said incompatible information.

34. A system according to claim 13, wherein said user interface further comprises a graphical user interface.

35. A system for balancing orders, executions and allocations associated with trading on the financial markets, said system comprising:
client-side booking interface for processing trade information from clients;
clearance-side booking interface for processing trade information received from external systems;
at least one database for storing and information received by said client-side booking interface and said clearance-side booking interface;
trade processing framework for receiving said trade information from said client-side booking interface and said clearance-side booking interface, logging said trade information into said database and validating said trade information;
wherein said trade processing framework compares said trade information from said client-side booking interface to said trade information from said clearance-side booking interface; wherein said validating includes identifying unmatched pairs of said trade information; wherein said system provides an output identifying said unmatched pairs of said trade information; and wherein said balancing system functions in real-time.

36. A system according to claim 35, wherein said system further comprises a database to store, sort and retrieve trade data.

37. A system according to claim 35, wherein said system further comprises a database to store, sort and retrieve customer information.

38. A system according to claim 35, wherein said system further comprises a database to store, sort and retrieve product information.

39. A system according to claim 35, wherein said system further comprises a database to store, sort and retrieve trade figuration.

40. A system according to claim 35, wherein said system further comprises a database to store, sort and retrieve allocation rules.

41. A system according to claim 35, wherein said system further comprises a messaging module to query said trade information and wherein said messaging module prepares messages with respect to said trade information.

42. A system according to claim 35, wherein said clearance-side booking interface exchanges information with third parties

43. A system according to claim 35, wherein said clearance-side booking interface exchanges information with ADP.

44. A system according to claim 35, wherein said clearance-side booking interface exchanges information with DTC.

45. A system according to claim 35, wherein said clearance-side booking interface exchanges information with the exchanges.

46. A system according to claim 35, wherein said trading processing framework receives, logs and validates said trade information.
